(19) United States
(12) Patent Application Publication
(10) Pub. No.: US 2011/0055340 A1
(43) Pub. Date: Mar. 3, 2011

(54) Mobile Social Networking Systems and Methods

(76) Inventor: Jay Christopher Bautista, Dallas, TX (US)

(21) Appl. No.: 12/844,706

(22) Filed: Jul. 27, 2010

Related U.S. Application Data
(60) Provisional application No. 61/237,167, filed on Aug. 26, 2009.

(51) Int. Cl. G06F 15/16; G06F 17/30

(52) U.S. Cl. 709/206; 709/204; 707/769; 707/E17.014

(57) ABSTRACT

Embodiments of the present disclosure generally provide a system and method for locating and communicating with a desired individual. The method includes receiving location information from a first communication device associated with a first user. A database is queried based on the received location information, and a result of the query is communicated to the first communication device. The result may be information associated with a second user. Communications from the first communication device may be relayed to a second communication device associated with the second user such that a first identifier associated with the first communication device is concealed from the second communication device. The location information may be a text message from the first communication device.

### CROSS REFERENCE TO RELATED APPLICATION

This application claims the benefit under 35 U.S.C. §119(e) of U.S. Provisional Patent Application Ser. No. 61/237,167 filed on Aug. 26, 2009 in the United States Patent and Trademark Office entitled “A social networking application for mobile phones used to discover people with a desired quality.”

### TECHNICAL FIELD

The present disclosure generally relates to social networking, and more particularly to social networking systems allowing location-aware, anonymous communication between communication devices.

### BACKGROUND

Mobile social networking applications may require specific hardware requirements (e.g. global positioning system “GPS”) or specific carrier network requirements (e.g. use of signal triangulation). Certain social networking application may also require specific software to be installed on the mobile communication device. When GPS or signal triangulation is used to locate a mobile communication device of a user, the user may feel as if the system is tracking the user's whereabouts and movements. Moreover, when communicating to others through conventional social networking systems, personally identifiable information may be made known to the other user.

### SUMMARY

Embodiments of the present disclosure generally provide a social networking system and method for locating and communicating with a desired individual. The method includes receiving location information from a first communication device associated with a first user. A database is queried based on the received location information, and a result of the query is communicated to the first communication device. The result may be information associated with a second user. Communications from the first communication device may be relayed to a second communication device associated with the second user such that a first identifier associated with the first communication device is concealed from the second communication device. The location information may be a text message from the first communication device.

Further embodiments of a method according to the present disclosure include receiving and storing a geographic coordinate that is determined based on the received location information. The result of the query may be based on this geographic coordinate. In addition, sending messages to the first and second communication devices from a device associated with a short code may facilitate communication between the first and second communication devices.

In one embodiment, the social networking system of the present disclosure may allow a user to determine if a desired user is currently in a particular location without allowing a location of the user to be determined. This may allow users to interact with the social networking system without fear that the social networking system is tracking their location or their movement through their mobile communication device or endpoint.

An additional technical advantage of the system includes the ability to communicate with a desired individual that may be previously unknown to the individual without disclosing personally identifiable information to the other party, or having a communication device of the other party determine such personally identifiable information. For example, in accordance with the teaching of the present disclosure, an individual may communicate with another individual with out revealing his telephone number. Thus, the communication may be anonymous and when the communication ends, any additional unwanted contact or communication may be avoided.

A further technical advantage may be an accessible mobile social networking system that does not require certain hardware or software to be installed on a mobile communication device. Rather, the mobile communication devices in accordance with embodiments of the present disclosure may use a specific process that allows users of many different types of communication devices to socially network without technology upgrades, improvements, or special software.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates a social networking system in accordance with a particular embodiment of the present disclosure;

FIG. 2 is a flow diagram illustrating a method of creating a social networking account according to an embodiment of the present disclosure; and

FIG. 3 is a flow diagram illustrating a method of locating and communicating with an individual according to an embodiment of the present disclosure.

### DETAILED DESCRIPTION

The present disclosure generally provides systems and methods for communicating with others in a defined geographic area. This communication may be through location-aware text messaging. In certain embodiments, there may be double-blind communication between the parties, such that personally identifiable information of one party may be concealed from the other party. The teachings of the present disclosure provide a system and method for searching for an individual in a predefined geographic location and communicating anonymously with that individual. Users of systems and methods in accordance with the present disclosure may also exchange photographs or other information that may have been provided to the system and stored as data in a user's profile.

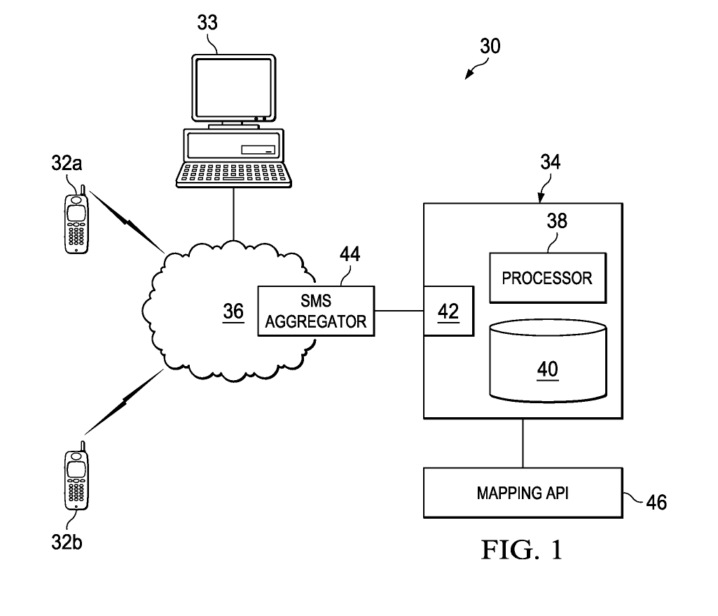

It should be understood that the diagrams shown in FIGS. 1-3 are for illustrative purposes only and that other suitable mobile social networking systems and methods may be used in conjunction with or in lieu of the illustrated systems and methods according to embodiments of the present disclosure.

Referring to the drawings, and particularly to FIG. 1, a social networking system 30 according to embodiments of the present disclosure is illustrated. The social networking system 30 includes a plurality of endpoints 32a and 32b, each endpoint has the ability to establish communication sessions between each other and/or a social networking server 34, using communication network 36. Such communications may be accomplished using any audio and/or video means, including signals, data or messages transmitted through voice devices, text chat, web sessions, facsimile, instant messaging and e-mail. Communication between endpoints and/or social networking server 34 may also be made using voice, instant messaging (IM), short message service (SMS) text messaging or any other suitable communication method. The endpoints 32a and 32b may be any suitable communication device including a mobile communication device operable to send and receive text messages, such as a mobile phone. Computer 33 may also be an endpoint of social networking system 30. Computer 33 may be any type of computing device that receives input data, processes that data through computer instructions in a program, and generates output data. Such computer can be a hand-held device, laptop or notebook computer, desktop computer, minicomputer, mainframe, server, mobile phone, smart phone, personal digital assistant, other device, or any combination thereof.

The communication network 36 may be any network capable of transmitting audio and/or video telecommunication signals, data, and/or messages, including signals, data or messages transmitted through text chat, instant messaging and e-mail across multiple cities and geographic regions. The communication networks 36 may be implemented as a local area network (LAN), wide area network (WAN), global distributed network such as the Internet, an intranet, extranet, or any other form of wireless or wireline communication network. Generally, the communication network 36 provides for the communication of packets, cells, frames, or other portions of information between endpoints 32a and 32b, computer 33, and/or social networking system 34. The communication network 36 may enable communications between and among any number and combination of endpoints and computers/servers.

It will be recognized by those of ordinary skill in the art that endpoints 32a and 32b and computer 33 may be any combination of hardware, software, and/or encoded logic that provide communication services to a user. For example, endpoints 32a and 32b may include a telephone, a computer running telephony software, a video monitor, a camera, an IP phone, a cell phone or any other communication hardware, software, and/or encoded logic that supports the communication of packets of media (or frames) using communication network 36. Although FIG. 1 illustrates a particular number and configuration of endpoints, computers, and servers, social networking system 30 contemplates any number or arrangement of such components for communicating media.

The social networking server 34 may include a processor 38, a memory module 40, and an SMS gateway 42. The SMS gateway 42 may serve to couple social networking system 34 with the communication network 36. The processor 38 may use a memory lookup, a database or other memory module, such as memory module 40, in performing searches and other operations according to embodiments of the present disclosure. The processor 38 may be a microprocessor, controller, or any other suitable computing device or resource. The memory module 40 may be any form of volatile or non-volatile memory including, without limitation, magnetic media, optical media, random access memory (RAM), read-only memory (ROM), removable media, or any other suitable local or remote memory component.

It will be recognized by those of ordinary skill in the art that social networking server 34 may include any number of processors or memory modules to accomplish the functionality and features described herein. The processor 38 and/or memory module 40 associated with social networking server 34 may be centrally located (local) with respect to one another, or distributed throughout communication network 36. Furthermore, any or all of the components illustrated as part of social networking server 34 may be separate from social networking server 34 and/or distributed locally or remotely from social networking server 34.

The social networking system 30 may also include an SMS aggregator 44. The SMS aggregator 44 may be provided by OpenMarket® and may allow social networking server 34 to receive and understand SMS text messages received from endpoints 32a and 32b. The messaging protocols may be proprietary protocols that have been developed by different vendors, and thus may not be compatible with each other. The SMS aggregator 44 may also allow social networking server 34 to send understandable SMS text messages to endpoints 32a and 32b. This aggregation function of SMS aggregator 44 facilitates these communications because the social networking server 34 is operable to communicate with the SMS aggregator 44 and the SMS aggregator 44 is operable to communicate by a plurality of text messaging protocols. For example, the SMS aggregator 44 may allow the social networking system 30 to accommodate communications from any telecommunication carrier, such as AT&T, T-Mobile, Verizon, Sprint, etc.

The social networking system 30 may also include mapping application programming interface (“API”) 46. The mapping API 46 may communicate with social networking server 34. The mapping API 46 may also be operable to determine a set of geographic position coordinates from textual location in accordance with an embodiment of the present disclosure. The mapping API may use any suitable algorithm or computer operable logic that performs a mapping function. One Mapping API that is known in the art was developed and provided by Google. Mapping APIs in accordance with the teaching of the present disclosure may provide a geocoding service that is based on a street address, street intersection, city, state, or any other suitable geographic designation. In certain embodiments, the mapping API 46 may receive a point of interest (“POI”) and return a geographic coordinate associated with that point of interest. For example, the mapping API may allow selection of coffee shop that has been classified as a point of interest. The mapping API 46 may determine geographic coordinates associated with the selected coffee shop. A Mapping API with this functionality may be provided by NAVTEQ.

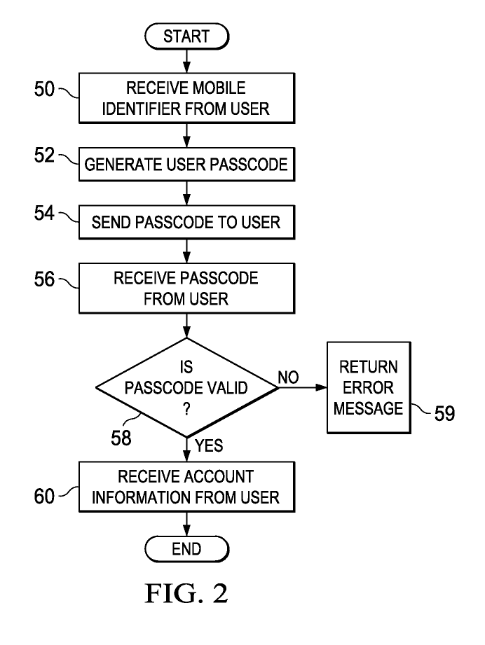

FIG. 2 illustrates a flow diagram of a method for a user to employ some of the components of FIG. 1 to set up an account according to an embodiment of the present disclosure. The method begins at step 50 where the social networking server 34 receives a mobile phone number associated with the user. The user may use computer 33 and direct a web browser to a specific uniform reference locator (“URL”) and receive a webpage requesting the user to set up an account. To initiate setting-up an account, the user may enter a mobile identifier, such as a telephone number of a mobile communication device of the user into a field of the website. Receiving the telephone number informs the social networking server 34 that the user is interested in creating an account.

Once a mobile identifier is received from the user, the social networking server 34 may generate a user passcode at step 52. The passcode may be a random alphanumeric character of any suitable length. In certain embodiments, the passcode may be a series of numbers and letters at least four characters in length. The passcode may be sent to the user at step 54. The passcode may be sent to the user in the form of an SMS text message that the user can receive on mobile communication device 32a or 32b. The passcode may be sent using the communication network 36 and directed to the mobile identifier input by the user at step 50.

If the user wishes to continue with the account registration, the passcode received as a text message may be entered into a field of the website. This action informs social networking server 34 that it is communicating with an individual associated with the mobile identifier that was provided at step 50. This may be important to prevent unauthorized use of the social networking system 30. By requiring a matching identifier to access certain functionality of the social networking server, a program that randomly generates numbers that appear to be telephone numbers may be prevented from disrupting the system.

At step 58, whether the passcode is valid or not is determined. If the passcode is not valid, then an error message may be displayed to the user on the webpage. If the passcode is determined to be valid, then the user may be presented with a webpage that allows the user to enter in more detailed account information to complete the account registration process at step 60.

The additional detailed information may be used to complete a profile of the user. Some of this information may also be used to classify the user as included in a certain demographic or demographics. This information may be referred to as demographic information. The additional information may include the user's post office address, e-mail address, additional telephone numbers, personal information about the user, age of the user, sex of the user, and any other information about the user. All of this additional detailed information may be stored in a database associated with social networking server 34. In particular, the information may be stored in memory module 40 and may be organized as a database record associated with a unique identifier identifying a particular user. The unique identifier may be provided by the user or generated by the social networking server 34. In certain embodiments, the user may upload a photograph, which may be stored by the in memory module 40 and associated with the database record of the user. By entering identifying information, such as the passcode or username, the user may access the user profile and modify it at a later date. Once the detailed account information is received from the user, the method ends.

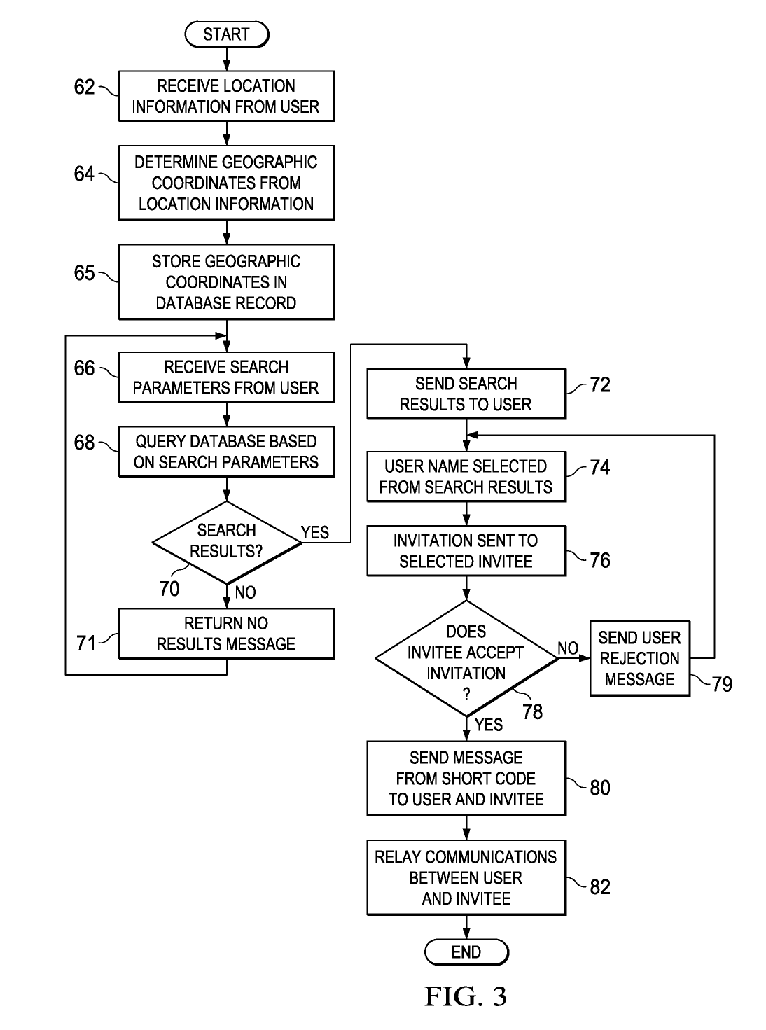

FIG. 3 illustrates a flow diagram of a method for a user to use some of the components of social networking system 30 according to embodiments of the present disclosure to socially network. The method begins at step 62 where location information is received from the user. The user location information may be provided when the user sends a text message to a short code associated with the social networking server 34. In certain embodiments, the text message may be an SMS message communicated to a short code.

A short code is a special telephone number that is significantly shorter than a full telephone numbers. Short codes typically comprise three (3) digits for carrier specific codes and five (5) to six (6) digits for general codes available across different carrier networks. Similar to the manner in which a full phone number may be used to address an SMS text message, a short code may be used to address an SMS text messages as well. A short code may have the advantage of being easier for a user to remember or to dial than a full phone number.

The user may communicate with social networking server using endpoint or mobile communication device 32a. In certain embodiments, the user may be at a coffee shop, bookstore, or a bar. The user may desire to know if there are any individuals that the user might be interested in meeting and possibly getting to know. The systems and methods disclosed herein are not limited to a dating application. The systems and methods according to an embodiment of the present disclosure are applicable in a variety of situations. For example, a homeowner may be desire to know if there is an individual within close proximity that has plumbing knowledge that may be able to assist with the homeowner's plumbing problem. The homeowner may be at home or at a home improvement store when this information is desired.

The message may be any message that identifies the user's geographical location. For example, the user may communicate a geographic location in text. The text may be in the form of “@ <user location>”. For example, the user may text “@ Greenville and Royal, Dallas, Tex.” or just simply “@ Dallas, Tex.” as a SMS text message to short code 94949. This short code may be used for communication of commands and keywords to social networking server 34.

In certain embodiments, it may not be necessary for a user to the obtain information associated with the global position of a communication device associated with the user as determined by a global positioning system. Moreover, locating the position of a mobile communication device associated with the user by signal triangulation also may not be necessary. Rather, it may be sufficient for the user just to know approximately an address where that user is located. This may be advantageous to the user because the whereabouts of the user may not be tracked by the social networking system 30. Rather, the social networking system 30 may have no information regarding the location of the user other than the information affirmatively provided by the user. Therefore, if the user is not at the location provided or leaves that location to go to another location, the social networking system 30 may not have accurate information regarding the user's location.

At step 64, the location information provided by the user may be used by social networking system 30 to determine a geographic position. In accordance with certain embodiments, the location information may be converted to coordinates using a mapping algorithm or software. In certain embodiments, the mapping software may be an application programming interface (“API”) provided by Google. The social networking server 34 may receive a message in the form of “@ <user location>”. This message may be communicated via SMS text message from a mobile device associated with the user to the social networking server 34. The social networking server 34 may employ the mapping API 46 to determine coordinates of a geographic position associated with the location information. These coordinates may be in a form that indicates a latitude and longitude value or range of values. For example, the values of latitude and longitude of a particular street address received as location information may be expressed in the form 32.8229679, −96.7864144.

The geographic position of the user determined by the mapping API 46 may be stored in a database associated with memory module 40 at step 65. The processor 34 and the memory module 40 may associate the geographic position information with the user's profile that may have been stored as a database record. In the form of the database record, the user's profile may be used in a search to determine other user profiles that have similar geographic positions indicating that that user is within a certain geographic location. The geographic position information of the user may also be searched and accessed based on the geographic position associated with the geographic location of the user.

At step 66, search parameters and a search command may be received from the user, and the search parameters may be used to query the database at step 68. The parameters and the search command may be in the form of an SMS text message sent from mobile communication device 32a to a short code associated with social networking server 34. For example, the user may text “search” to 94949. The search parameters may be in the form of keywords that the system may include in a query of the database. The keywords may specify characteristics of an individual in whom the user may be interested. The search parameters may also be a geographic range within which to search. For example, the user may specify that he is interested in individuals that are located within two miles of the location provided by the user. In certain embodiments, if no geographic parameter is received, a default geographic range of five miles may be used in the search query.

The search parameters may be used in a structured query language (SQL) query of the database. User profiles that meet the geographic range and the keywords provided may be returned as results of the query. In certain embodiments, the database may be searched for geographic positioning coordinates that fall within the geographic range of the geographic search parameters.

Whether there are entries that match the search criteria in the database is determined at step 70. If there are no matching entries, a message indicating that no search results were found may be returned to the mobile communication device 32a associated with the user at step 79. After sending the no results message, the method returns to step 66, and the user may enter a different set of search parameters.

If database entries matching the search parameters are found, these search results may be sent to the user at step 72. The information communicated to the user may be in the form of an SMS text message to the mobile communication device 32a associated with the user. In certain embodiments, anonymity of the individuals associated with the resulting entries may be maintained because the results communicated to the user may conceal the identity of the associated individual. The results returned to the user may only include a username or screen name associated with the resulting entry. In certain embodiments, a mobile communication device 32a that is operable to access the Internet may allow the user to access a link associated with the username. When the link is accessed the user may be directed to a webpage that includes additional information about the individual. In other embodiments, the user may text the command “profile <screen name>” or other identifier to 94949 to receive additional information about the individual associated with the search results. The additional information may be information authorized for general viewing by the individual.

At step 74, the user may select a user name or screen name from the search results. The user may select the desired user name by selecting it with the mobile communication device 32a that received the search results. Upon receiving a selection by the user, the system may communicate an invitation to a mobile communication device 32b associated with the selected individual or invitee at step 76. The system may perform this action by referring to the database to determine a number of the mobile communication device 32b associated with the invitee and send a text message to this number. The text message may be an SMS text message and may indicate to the invitee that the user wishes to initiate a chat. The invitee may be provided with the username associated with the user via this text message.

It may be determined whether the invitee accepts the invitation to chat at step 78. If the invitee does not accept the invitation to chat, the social networking server 34 sends a message to the user indicating that the invitee rejected the user's invitation at step 79. Then, the user is returned to step 74 and may select a different username from the search results.

If the invitee accepts the invitation to chat, then at step 80 a message may be sent to the invitee and the user from a device associated with a particular code. The code may be a short code that allows a message to be sent to the invitee 32b and the user 32a without either having knowledge of the code. For example, a text message may be sent to the user and the invitee from the social networking server 34, which may be associated with the short code “38172.” By sending messages from the same short code to the invitee and the user, the system may be operable to relay the communications between the invitee and the user at step 82. By relaying the communications, any identifier associated with the communication device of the user 32a may remain unknown to the invitee 32b. Likewise, an identifier associated with the communication device used by the invitee 32b may remain unknown to the user 32a.

In an alternate embodiment, a code to allow the invitee and the user to communicate using voice transmission may be communicated to the invitee 32b and the user 32b. With this method, the system may relay voice communications between the invitee and the user such that the respective numbers associated with the respective mobile communication devices remain anonymous.

Because the system is relaying the communications between the invitee and the user, in certain embodiments, contextually relevant advertisements may be inserted in the text messages sent be the invitee 32b or the user 32a. The advertisements may be selected to correspond to the time of day, week, month, or year at which the message is sent, the location information provided by the user, the demographic information associated with the user, or any other suitable criteria. In this manner, the user or the invitee may be alerted to a particularly relevant product, service, or offer that they may not have immediately been aware of, and the system may generate revenue by charging advertisers a fee to include their advertisements in the communications sent from social networking server 34. In still other embodiments, the invitee and/or the user may be sent trivia questions by the system. In this manner, the invitee and the use may engage in an anonymous game of trivia in accordance with teaching of the present disclosure.

The invitee and the user may use the relay functionality of the system to communicate with each other through text messaging. In certain embodiments, the user may text the command “flirt” to the invitee. In response to receiving this command, the social networking server 34 may send a random message that may be interpreted as a pick-up line to the invitee 32b. In the alternative, the user may send the user's own message by texting “flirt <name> <user created pick-up line>” to 94949.

According to a certain embodiment, the user and/or the invitee may give the system a command that allows a photo or other image to be accessed by the other party. For example, the user may text a specific keyword to a short code associated with the system using his mobile communication device 32a. An algorithm may be used to create a shortened, obscured and re-directed, wireless application protocol (“WAP”) uniform resource locator (“URL”). URL shortening is a technique where a web page is made available under a very short URL in addition to the original address. For example, the forty-three character long URL for a Wikipedia article, http://en.wikipedia.org/wiki/URL_shortening, can be accessed through a sixteen character long alternative, http://wee.am/86. In certain embodiments, the URL shortening may be provided by tinyURL.com, bit.ly or other suitable URL shortening provider. Because the photo is accessed and provided by the system, a layer of protection is provided to keep the user's or the invitee's personally identifiable information private. In alternative embodiments, a user may provide a photo using a multimedia messaging service (“MMS”) that extends the core SMS capability to allow sending and receiving of multimedia content.

The system and method in accordance with embodiments of the present disclosure may provide a location-aware search and anonymous communication between users. A user may locate an individual in a defined geographic location, invite the individual to communicate, communicate with that individual anonymously, and provide that individual with a photograph. In certain embodiments, all of the foregoing may be accomplished without the use of a global positioning system or a conventional signal triangulation process that locates a mobile communication device. Because the system may not rely on a global positioning system or signal triangulation, the location of the mobile communication devices in communication with the system may be unknown to the social networking system 30. This may offer the invitee, the user, and others using the system additional comfort that the system may not be tracking them.

If the user and the invitee become comfortable with the communication, they can choose to meet in person and end their communication through the relay of the system. In certain embodiments, a text message giving the social networking server 34 a command such as “bye” may be the hang-up command. When the hang-up command is given the social networking server 34 may release its relay function by allowing the short code of the social networking server 34 to be disassociated with the user and/or the invitee. If the short code is disassociated with the invitee, the user may then communicate with another user using the relay function of the social networking server 34. Similarly, the social networking server may be programmed to hang-up after a predetermined period of inactivity by the user or the invitee. Similar to the hang-up function, the social networking server may be programmed to disassociate the user's database record from the location information provided by the user and the corresponding geographic coordinates. This may be accomplished when other location information is received from the user, the user gives a command to the social networking server 34, or a predetermined time period elapses without user activity. In certain embodiments, the location information disassociation may occur after forty-eight hours of inactivity, which may cause the geographic coordinates to be reset to zero or some other default value.

Some of the steps illustrated in FIGS. 2 and 3 may be combined, modified, or deleted where appropriate, and additional steps may also be added to the flow diagrams. Additionally, steps may be performed in any suitable order without departing from the scope of the invention.

As will be appreciated by one skilled in the art, the present disclosure may be embodied as a system, method or computer program product. Accordingly, embodiments of the present disclosure may take the form of an entirely hardware embodiment, an entirely software embodiment (including firmware, resident software, micro-code, etc.), or an embodiment combining software and hardware aspects that may all generally be referred to herein as a circuit, module or system. Furthermore, embodiments of the present disclosure may take the form of a computer program product embodied in any tangible medium of expression having computer-usable program code embodied in the medium.

Any combination of one or more computer usable or computer readable mediums(s) may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations, and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure and the following claims.

What is claimed is:

1. A method of social networking using a communication device:
receiving location information from a first communication device associated with a first user;
querying a database based on the received location information;
sending a result of the query to the first communication device, the result being information associated with a second user;
relaying a communication from the first communication device to a second communication device associated with the second user such that a first identifier associated with the first communication device is concealed from the second communication device.

2. The method of claim 1, wherein the location information comprises a text message from the first communication device.

3. The method of claim 2, further comprising:
receiving a geographic coordinate based on the location information;
storing the geographic coordinate in the database; and
wherein the result of the query is at least partially based on the geographic coordinate.

4. The method of claim 1, wherein communicating the result of the query to the first communication device comprises communicating a text message including the result to the first communication device.

5. The method of claim 1, further comprising:
receiving the first identifier associated with the first communication device;
receiving the second identifier associated with the second communication device; and
storing the first identifier and the second identifier in the database.

6. The method of claim 1, wherein querying the database based on the received location information comprises querying the database for a geographic coordinate indicating that a second location associated with the second user is a predetermined distance from a first location associated with the location information.

7. The method of claim 1, further comprising:
receiving a text message including a keyword from the first user; and
querying the database based on the received keyword.

8. The method of claim 1, further comprising:
sending a first message from a device associated with a short code to the first communication device;
sending a second message from the device associated with the short code to the second communication device;
wherein the first communication device communicates with the second communication device through the device associated with the short code; and
wherein the short code is transparent to the first communication device and the second communication device.

9. The method of claim 1, further comprising sending a contextually relevant advertisement to the first communication device, the contextually relevant advertisement being based on criteria selected from the group consisting of: the location information, demographic information of the user, or a sending time of the contextually relevant advertisement.

10. A social networking system, comprising:
a processor coupled to a memory module, the processor being programmed to:
receive location information from a first communication device associated with a first user;
query a database based on the received location information, a result of the query being information associated with a second user; and
relay a communication from the first communication device to a second communication device associated with the second user such that a first identifier associated with the first communication device is concealed from the second communication device.

11. The system of claim 10, wherein the location information comprises a text message from the first communication device;
the processor further operable to:
receive a geographic coordinate based on the location information;
store the geographic coordinate in the database; and
wherein the result of the query is at least partially based on the geographic coordinate.

12. The system of claim 10, wherein the processor is further operable to communicate the result of the query as a text message including the result to the first communication device.

13. The system of claim 10, wherein the processor is further operable to:
receive the first identifier associated with the first communication device;
receive a second identifier associated with the second communication device; and
store the first identifier and the second identifier in the database.

14. The system of claim 10, wherein the processor is further operable to query the database for a geographic coordinate indicating that a second location associated with the second user is a predetermined distance from a first location associated with the location information.

15. The system of claim 10, wherein the processor is further operable to:
receive a text message including a keyword from the first user; and
query the database based on the received keyword.

16. The system of claim 10, wherein the processor is further operable to:
send a first message from a device associated with a short code to the first communication device;
send a second message from the device associated with the short code to the second communication device;
wherein the first communication device communicates with the second communication device through the device associated with the short code; and
wherein the short code is transparent to the first communication device and the second communication device.

17. The system of claim 10, where in the processor is further operable to send a contextually relevant advertisement to the first communication device, the contextually relevant advertisement being based on criteria selected from the group consisting of: the location information, demographic information of the user, or a sending time of the contextually relevant advertisement.

18. A non-transitory computer-readable storage medium with an executable program stored thereon, wherein the program instructs a processor to perform operations comprising:
receiving location information from a first communication device associated with a first user;
querying a database based on the received location information;
communicating a result of the query to the first communication device, the result being information associated with a second user; and
relaying a communication from the first communication device to a second communication device associated with the second user such that a first identifier associated with the first communication device is concealed from the second communication device.

19. The non-transitory computer-readable storage medium of claim 18, wherein the location information comprises a text message from the first communication device; and
wherein the program instructs the processor to perform operations further comprising:
receiving a geographic coordinate based on the location information;
storing the geographic coordinate in the database; and
wherein the result of the query is at least partially based on the geographic coordinate.

20. The non-transitory computer-readable storage medium of claim 18, wherein the program instructs the processor to perform operations further comprising:
sending a first message from a device associated with a short code to the first communication device;
sending a second message from the device associated with the short code to the second communication device;
wherein the first communication device communicates with the second communication device through the device associated with the short code; and
wherein the short code is transparent to the first communication device and the second communication device.
